(19) United States
(12) Patent Application Publication
(10) Pub. No.: US 2007/0029310 A1
(43) Pub. Date: Feb. 8, 2007

(54) Heating device

(76) Inventors: Luis Schwarzenberger, Lans (AT); Josef Gunsch, Mils (AT)

Correspondence Address: Thomas M. Saunders;Brown Rudnick Berlack Israels LLP, One Financial Center, Box IP, Boston, MA, 02111, US

(21) Appl. No.: 11/540,367

(22) Filed: Sep. 29, 2006

Related U.S. Application Data
(63) Continuation of application No. PCT/AT05/00110, filed on Mar. 30, 2005.

(30) Foreign Application Priority Data
Apr. 1, 2004 (AT) GM 247/2004

(51) Int. Cl. H05B 6/02

(52) U.S. Cl. 219/600

(57) ABSTRACT

This invention concerns a heating device comprising at least one heating element which is arranged within a wall, wherein the internal space of the wall, which accommodates the at least one heating element, is at least partially filled with sand from eruptive rock.

The invention concerns a heating device, in particular a heating rod for thermal cabins, comprising at least one heating element which is arranged within a wall. The invention further concerns a thermal cabin.

Heating devices, in particular heating rods which have a preferably electrical heating element within a ceramic wall are already used for heating thermal cabins. Hitherto quartz sand has been introduced between the heating element and the wall. It will be noted however that it has been found that the quartz sand collapses into itself in particular when the heating rods are installed in a standing position in the usual fashion and thus is no longer available to a partial region for the transfer of heat from the heating element to the wall.

In order to solve that problem the invention proposes that the internal space of the wall, which accommodates the at least one heating element, is at least partially filled with sand from eruptive rock.

Tests have shown that that sand of eruptive rock (lava sand) does not collapse into itself even when used for a prolonged period of time. The filling level and the operational capability of the heating rod is thus maintained over a long period of time.

Further advantages and details will be described more fully with reference to the description of the drawings hereinafter.

In the drawing:

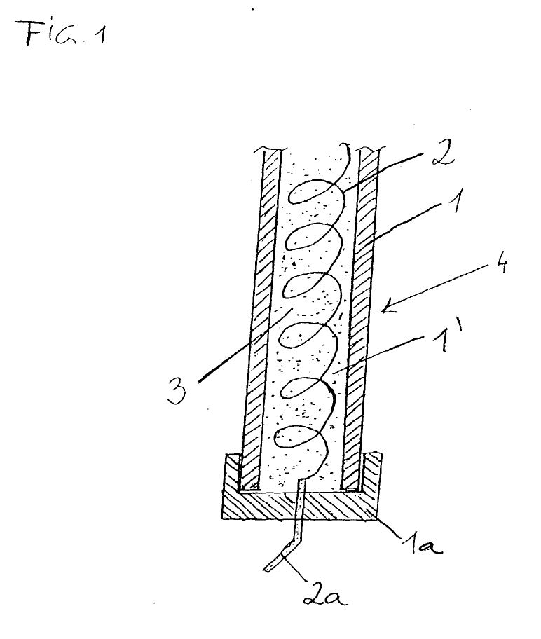

FIG. 1 shows a longitudinal section through a part of an embodiment of a heating device according to the invention, and

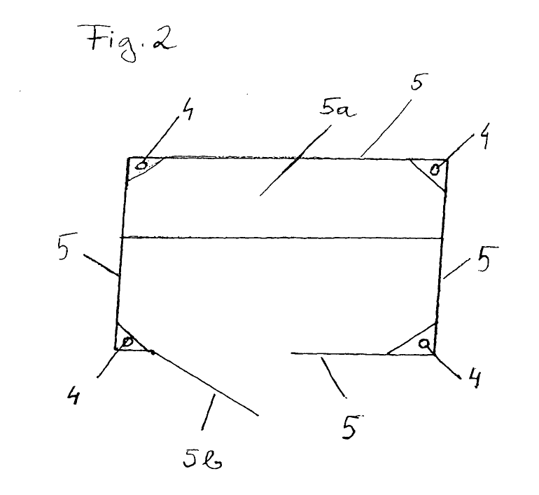

FIG. 2 shows a diagrammatic plan view of an embodiment of a thermal cabin according to the invention.

The heating device which is generally identified by reference 4 in FIG. 1 has a wall 1 of ceramic material, the wall affording good heat resistance. It is substantially in the form of a hollow-cylindrical rod. Only the lower end of that rod is shown in FIG. 1. The upper end can be of substantially the same configuration.

The lower end of the rod-shaped wall 1 is closed by a cover cap 1 a which also comprises ceramic material and which carries an electrical connecting lug 2a. That electrical connecting lug leads to the helical heating element 2 (electrical resistance heating wire).

Now, in accordance with the invention the internal space 1′ of the wall 1, in which the heating element 2 is also disposed, is filled with sand from eruptive rock (lava sand). In the present embodiment the heating rod is completely filled.

A grain size of at most 0.2 mm to 0.5 mm has proven itself as the grain size of the lava sand used. The lava sand has at least one and preferably a plurality of the following components: plagioclase, leucite, nepheline, clinopyroxene, olivine, magnetite and/or apatite.

The invention also concerns a thermal cabin having such a heating device. FIG. 2 shoes a diagrammatic plan view illustrating an embodiment of a thermal cabin according to the invention. The thermal cabin is surrounded by walls 5 and is of a rectangular configuration in plan. A bench 5a can be disposed in the interior thereof. It is possible to enter and leave the thermal cabin by way of a pivoting door 5b. A respective heating element 4 according to the invention is arranged vertically in each of the corners of the thermal cabin.

It will be appreciated that the invention is not limited to the illustrated embodiments. For example the arrangement of the heating elements and the shape of the thermal cabin can differ completely from the view shown in FIG. 2. The heating device itself does not necessarily have to be of a rod-shaped configuration. Rather, planar configurations are also certainly conceivable and possible.

1. A heating device comprising at least one heating element which is arranged within a wall,
wherein the internal space of the wall, which accommodates the at least one heating element, is at least partially filled with sand from eruptive rock.

2. A heating device according to claim 1 wherein the grain size of the sand of eruptive rock is at most 0.2 mm to 0.5 mm.

3. A heating device according to claim 1 wherein the sand consists of broken or crushed eruptive rock.

4. A heating device according to claim 1 wherein the sand from eruptive rock includes at least one of the following components: plagioclase, leucite, nepheline, clinopyroxene, olivine, magnetite and/or apatite.

5. A heating device according to claim 1 wherein the heating element provided is an electrical heating wire.

6. A heating device according to claim 1 wherein the heating element provided is a helically extending electrical heating wire.

7. A heating device according to claim 1 wherein the wall is formed substantially by a hollow-cylindrical rod.

8. A heating device according to claim 1 wherein the wall comprises ceramic material.

9. A heating device according to claim 1 wherein the internal space of the wall, which accommodates the at least one heating element, is substantially completely filled with sand from eruptive rock.

10. A heating device according to claim 1 which is a heating rod for thermal cabins.

11. A thermal cabin having at least one heating device according to claims 1.
